(19) United States
(12) Patent Application Publication
(10) Pub. No.: US 2008/0194238 A1
(43) Pub. Date: Aug. 14, 2008

(54) Wireless Terminal Having Information Exchange Facility, Information Exchange System and Method Using the Wireless Terminal

(76) Inventor: Sun Tae Kwon, Seoul (KR)

Correspondence Address: BIRCH STEWART KOLASCH & BIRCH, PO BOX 747, FALLS CHURCH, VA, 22040-0747, US

(21) Appl. No.: 11/913,929

(22) PCT Filed: Nov. 11, 2005
(86) PCT No.: PCT/KR05/03826

§ 371 Date: Nov. 8, 2007

(30) Foreign Application Priority Data
Nov. 11, 2004 (KR) 10-2004-0092111
Nov. 12, 2004 (KR) 10-2004-0092739

(51) Int. Cl. H04M 3/42

(52) U.S. Cl. 455/414.1

(57) ABSTRACT

A wireless terminal having data exchange function, and data exchange system and method using the same are disclosed. The improved terminal comprises a communication unit which communicates with another terminal; a memory which stores a data including a recognition data of a terminal; and a controller which requests a desired data to the other terminal through the communication unit, receives a requested data and performs a corresponding service.

### TECHNICAL FIELD

The present invention relates to a terminal, and in particular to a information exchange terminal having various functions.

### BACKGROUND ART

The applicant of the present invention has developed a novel electronic commerce technology in which it is possible to purchase a certain item that others have or wear as compared to a conventional method in which a customer visits a shopping mall and purchases a desired item. With the new above concept, the applicant of the present invention has invented a system in which an item that other have or wear is photographed or an item inherent number of the item is read using a barcode or a RF tag, and the photographed or read data are transferred to an electronic commerce server (Korean patent application No: 2002-57427, and filing date: Sep. 19, 2002). The above application is laid-open with Korean patent laid-open No. 2002-0083974 with a laid-open date of Nov. 4, 2002.

The applicant of the present invention has improved the above patent invention and has filed the international patent application with PCT/KR2004/001109. In the above patent application '109, each terminal is designed to build a shopping mall and store therein, so that the shopping malls of neighboring terminals communicate with each other for thereby purchasing a desired item as compared to the earlier application of the applicant of the present invention.

According to the above application, when a user having a certain terminal wants to purchase an item or clothes that another user positioned close to the above user has or wears, the user is connected with a corresponding terminal of another user and checks out the shopping mall and purchase a desired item. At this time, the terminal of a purchaser transmits a wireless signal of requesting a data to the peripheral terminal, and the peripheral terminal obtains an inherent code of the terminal which requests the data. Here, the terminal of a seller maintains connected with the terminal of the purchaser using the received inherent code and provides a shopping mall.

### DISCLOSURE OF INVENTION

### Technical Problem

Accordingly, it is an object of the present invention to provide various exchangeable data by improving a conventional terminal.

It is another object of the present invention to provide a terminal in which terminals positioned at a certain terminal are recognized using a recognition data or a status data or a service item data related with a GPS of peripheral terminals stored in the terminal, and a data is communicated between the terminals or the servers.

It is further another object of the present invention to provide a terminal in which a status data is communicated with an evidence data server or a data exchange terminal owner wherein various service data are exchanged, with various service data including a meeting data, a status data, a road corporation data, a reverse auction data, a joint purchase data, an electronic commerce data, a research data, a financial data, and a help request data during an emergency circumstance.

### Technical Solution

To achieve the above objects, in a terminal which communicates with at least one peripheral terminal and exchanges data, there is provided an improved terminal, comprising a communication unit which communicates with another terminal; a memory which stores a data including a recognition data of a terminal; and a controller which requests a desired data to the other terminal through the communication unit, receives a requested data and performs a corresponding service.

To achieve the above objects, the terminal according to another embodiment of the present invention is a terminal which communicates with at least one peripheral terminal and server and includes a communication unit for performing a communication function with other terminals or server, a memory for storing data including a recognition data of the terminal, and a controller for requesting a data of other terminal to the server through the communication unit and receiving a requested data and performing a corresponding service.

To achieve the above objects, the terminal according to further another embodiment of the present invention is a terminal which communicates with at least one peripheral terminal and server and includes a communication unit for performing a communication function with other terminals or server, a memory for storing data including a recognition data of the terminal, an input unit for receiving a user's selection, and a controller for requesting a data needed to other terminals through the communication unit, receiving a requested data, performing a service selected by the input unit and transmitting a result to the server.

In the terminal according to the embodiment of the present invention, it is possible to inquiry and recognize the statuses of peripheral terminals.

According to another embodiment of the present invention, the recognition data can be stored together with a time data at the time when the data is received, and/or a position data of a corresponding terminal and can be inquired.

In the terminal according to the embodiment of the present invention, the statuses of the peripheral terminals are inquired by time, and the positions of the same can be recognized.

According to the embodiments of the present invention, the recognition data stored in the memory are transmitted to a WAP server and are managed. Here, the WAP server may be a common server.

According to the embodiments of the present invention, the statuses of the terminals peripheral to a specific terminal are recognized on the internet or other communication units.

The terminal according to another embodiments of the present invention is designed to transmit an emergency help message stored in the memory to peripheral terminals.

According to the embodiments of the present invention, it is possible to request a help to peripheral terminals during an emergency using the terminal according to the present invention.

The terminal according to another embodiment of the present invention is capable of connecting with a previously set emergency contact through a broadband wireless communication unit and providing the data of the peripheral terminals stored in the memory.

The terminal according to another embodiment of the present invention is capable of transmitting a personal data request signal to one among the peripheral terminals in response to a user's operation and receiving and outputting a personal data of a terminal owner.

According to the embodiments of the present invention, it is possible to communicate the personal data such as a business name card using the terminal according to the present invention or to allow the users of the terminals to have meets based on the personal data of the peripheral persons.

To achieve the above objects, in a data exchange system which communicates with at least one first terminal and exchanges a data, there is provided an improved data exchange system, comprising a database which stores recognition data of a plurality of terminals including the first terminal and a service data corresponding thereto; and a server which transmits a service data to the first terminal based on a service request data inputted from the first terminal.

To achieve the above objects, in a data exchange system which communicates with at least one first terminal and receives a status diagram data which is the position data of the terminals including the first terminal from a mobile communication service company and exchanges the data, there is provided a data exchange system, comprising a database which stores the recognition data of a plurality of wireless terminals including a first terminal and a service data corresponding thereto; and a server which transmits a service data and the status diagram data to the first terminal in accordance with a service request data inputted from the first terminal.

To achieve the above objects, in a data exchange method which includes a database and a server and communicates with at least one terminal and exchanges data, there is provided an improved data exchange method, comprising a step in which the first terminal transmits a service request data to the server together with his recognition data; and a step in which the server transmits a service data corresponding to the service to the first terminal in accordance with the service request data.

### Advantageous Effects

As described above, the user can be provided with a desired service among the service items of the terminal using a data exchange system between terminals or between a terminal and a server according to the present invention. Since the user is easily provided with an electronic commerce, a meeting, a status diagram data, a research, a road corporation data, a joint purchase, a reverse auction, finance, emergency situation, etc., it is possible to achieve more convenient life. In addition, the arrangement statuses of the peripheral terminals are stored by the time, and an evidence material can be obtained with respect to a certain situation such as crime, accident or usual time. In the case of an emergency situation, certain help may be requested to the peripheral terminals. Data exchanges can be efficiently performed.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating a construction of a communication system having a terminal according to an embodiment of the present invention;

FIG. 2 is a schematic block diagram illustrating a construction of a mobile communication terminal according to all embodiment of the present invention;

FIG. 3 is a view of an example of a peripheral terminal inquiry screen according to the present invention;

FIG. 4 is a schematic view illustrating a construction of a communication system including a terminal according to another embodiment of the present invention;

FIG. 5 is a schematic block diagram illustrating a construction of a mobile communication terminal according to another embodiment of the present invention;

FIG. 6 is a view illustrating a service item data according to the present invention;

FIG. 7 is a view of an example of a status diagram screen according to the present invention;

FIG. 8 is a view illustrating a construction of a data exchange system according to an embodiment of the present invention;

FIG. 9 is a view illustrating various data flows in a data exchange method according to an embodiment of the present invention;

FIG. 10 is a flow chart illustrating an operation flow when a service of a data exchange method is an electronic commerce according to an embodiment of the present invention;

FIG. 11 is a view illustrating an operation flow when a service of a data exchange method is a meeting according to an embodiment of the present invention;

FIG. 12 is a view illustrating an operation flow when a service of a data exchange method is an emergency situation diagram according to an embodiment of the present invention;

FIG. 13 is a view illustrating an operation flow when a service of a data exchange method is a road (highway) corporation according to an embodiment of the present invention;

FIG. 14 is a view illustrating an operation flow when a service of a data exchange method is a research according to an embodiment of the present invention; and

FIG. 15 is a view illustrating an operation flow when a service of a data exchange method is a financial work according to an embodiment of the present invention.

### MODE FOR THE INVENTION

The preferred embodiments of the present invention will be described with reference to the accompanying drawings.

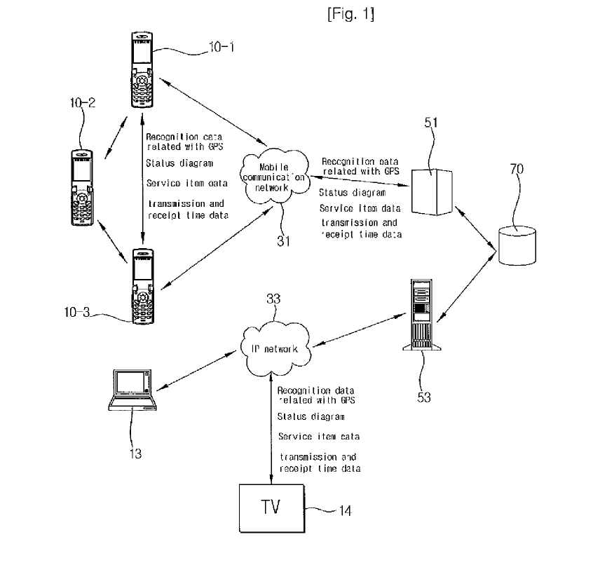

FIG. 1 is a schematic view illustrating a communication system having a terminal according to an embodiment of the present invention. As shown therein, the terminals 10-1, 10-2, and 10-3 according to the present invention performs a wired or wireless communication using at least one among a recognition data, a status data, a service item data, and a transmission and receipt time data, which are related with each other through the GPS. The terminals 10-1, 10-2 and 10-3 performs a wireless communication using at least one among a recognition data realted with the UPS through WAP server 51, a status data, a service item data and a transmission and receipt time data.

In addition, if necessary, the recognition data related with the GPS through the servers 51 and 53, status data, service item data, and transmission and receipt data may be displayed on the television 14 or the terminal 13. The data may be classified into the recognition data of the terminal of a family member, status data or service item data, and transmission and receipt data and may be displayed. Here, the communication method may be either a wired method or a wireless method. The terminals according to other embodiment of the present invention may be connected with a WAP server 51 through the mobile communication network. Here, the terminals 10-1, 10-2 and 10-3 may be a cellular phone, a notebook computer, a personal digital adaptor (PDA), a desktop computer, etc. In the present invention the terminals are not limited thereto and may be a telematics or other type terminals.

The web server 53 may access the database 70 managed by the WAP server 51. The users may get connected with the web server 53 using another terminal 13 through the internet. In the preferred embodiment of the present invention, the WAP server 51 and the web server 53 are separately shown. If necessary, the WAP and web servers 51 and 53 may be integrated and may be different server or may be divided into multiple servers.

The WAP server 51 may be installed at a mobile communication service company or may be installed at a separated service company. In the case that it is installed at a separate service company, the mobile communication service company or terminal can generate a status data which represents data including position data of the peripheral terminals.

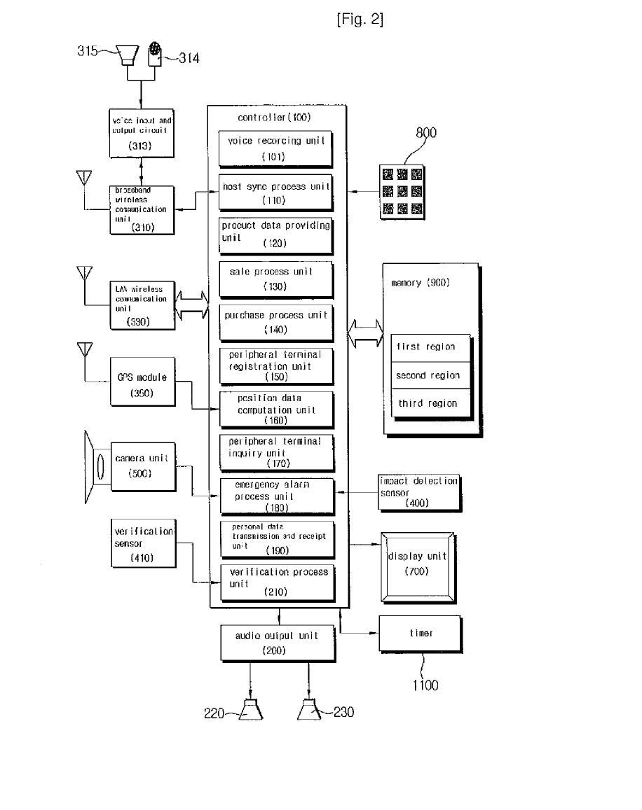

FIG. 2 is a schematic view of a constriction of a mobile communication terminal according to an embodiment of the present invention.

As shown therein, the terminal according to the present invention includes a LAN wireless communication unit 330 for communicating with other peripheral terminals, a memory 900 which stores terminal recognition data, a peripheral terminal registration unit 150 for transmitting a recognition data related with the GPS stored in the memory 900 through the LAN wireless communication unit 330, receiving a recognition data from at least peripheral terminal through the LAN wireless communication unit 330 and storing into a third region of the memory 900, a purchase processing unit 140 connected with one terminal of the terminals having the recognition data stored in the third region through the LAN wireless communication unit 330 for receiving various data including item data, transmitting a purchase request data and receiving and outputting a purchase process result data, a peripheral terminal inquiry unit 170 for outputting the data of the peripheral terminals stored in the third region of the memory 900 in response to an external request, a voice recording unit 101 for recording voices, and a timer 1100 for checking time. There may be further provided an output unit for outputting a process result in a form that the user can recognize. The controller 100 of the terminal is formed based on a software or hardware and may be changed in various forms. The construction of FIG. 2 may be functionally divided, and a single program may be provided so that all operation can be processed with one controller.

The memory 900 stores his own recognition data in the first region, the data and recognition data from the other wireless terminal into the second region, and the recognition data related with the GPS received by the peripheral terminal registration unit into the third region. The above classification is provided for necessary. Only one memory may be provided or a plurality of memories may be provided. The memory 900 may store status data, service item data and transmission and receipt time data.

The LAN wireless communication unit 330 may be a common wireless communication such as RF, DMB terminal, FM, AM, TRS, infrared ray (IrDa) etc. and may be a wireless communication module which supports a digital communication more advanced than a blue tooth and may be one of the above elements. In the case of the blue tooth communication, the blue tooth terminals set the connection with each other using an inherent code. The blue tooth terminals may communicate with one among peripheral terminals based on the user's set and selection.

The terminal according to another embodiment of the present invention may further include a broadband wireless communication unit 310. Here, the broadband wireless communication unit 310 may be a CDMA communication method or may be a LAN. The terminal is connected with the wireless internet through the broadband wireless communication unit 310 and finally connected with the WAP server 51 or the web server 53. In another embodiment of the present invention, the broadband wireless communication unit 310 may support voice communication together with a voice input and output circuit 313 including a microphone 314 and a speaker 315.

Each element of the controller 100 may be implemented by properly dividing the hardware and software and may be implemented with a single high speed microprocessor and may be integrated into one single chip together with the microprocessor in which there are provided the broadband wireless communication unit 310, the LAN wireless communication unit 330, and the controller 100 formed of almost circuits except for the antenna in the GPS module 350.

The memory 900 may be classified into a single flash memory or a memory installed in the terminal or a detachable chip card. In one embodiment of the present invention, a part of the data of the terminal users, a shopping mall data for an electronic commerce, a status data, a service item data and recognition data of the peripheral terminals may be separately stored in an external type chip card memory. Therefore, the user can easily use the terminal using other's terminal by changing a chip card. In addition, the user can use the data stored in the chip card at his personal computer or other terminal. The chip card has an enhanced security function with itself security function. The memory 900 is divided into multiple regions but may be changed in various constructions. If necessary, it may be changed based on the changes of at least three service item data. Only one memory may be used. Various data such as data of all terminals, electronic commerce data, meeting data, emergency situation data, research data, road corporation data, financial data, etc. may be stored therein.

The peripheral terminal registration unit 150 communicates with other peripheral terminals through the LAN wireless communication unit 330 and registers the recognition data of the same into the memory 900. Namely, the terminals are allocated with inherent recognition data and store into the memory 900. For example, in the case that the LAN wireless communication unit 330 is the blue tooth method, the recognition data may be a blue tooth recognition number. When the terminal operates, the peripheral terminal registration unit 150 transmits his inherent recognition number through the LAN wireless communication unit 330 and searches the recognition data received from other terminals. In one embodiment of the present invention, the peripheral terminal registration unit 150 stores the recognition data related with the received GPS into the third region of the memory 900. The peripheral terminal registration unit 150 may periodically transmit his recognition data with reference to the timer 1100 or may transmit the recognition data in response to the user's operation. In addition, the peripheral terminal registration unit 150 may periodically search the peripheral terminals with reference to the timer 1100 and may search the peripheral terminals based on the user's operation.

The recognition data of the registered peripheral terminals may be inquired through the peripheral terminal inquiry unit 170. The peripheral terminal inquiry unit 170 may provide the recognition data of the current peripheral terminals and a self-introduction data made by a person.

The terminal according to another embodiment of the present invention includes a product data providing unit 120 for providing a product data stored in the memory 900 and a terminal recognition data stored in the memory in response to a request from the other terminal, receiving a recognition data of the terminal and storing into the second region of the memory, and a sale process unit 130 for receiving a purchase request data including the second item data and the terminal recognition data from the other terminal and processing the purchase request. The memory 900 is provided with a product database similar with the database of the shopping mall of the conventional web and may download from the server or the personal computer. For example, the user receives an electronic tag of clothes, a bar code, a number, etc. through a reader connected with the terminal and receives the product data by inquiring the electronic tag, bar code, number, etc through the WAP server 51. The database needed for a shopping mall operation may be constructed by editing the price data. Namely, the memory 900 includes a product database of the online shopping mall in which clothes worn by the user or wearing items may be sold to others.

Here, the other terminal may request a product data through the LAN wireless communication unit 330. Namely, the person who wants to purchase clothes or items or accessory worn by nearby others operates his terminal. At this time, the terminal registers the recognition data of the peripheral terminals through the peripheral terminal registration unit 150. The peripheral terminal inquiry unit 170 of the terminal of the purchaser provides a list of the peripheral terminals on the display unit 700. The purchase process unit 140 of the terminal of the purchaser selects one from the list through a keypad 800 and is communicated with the selected terminal. In another embodiment of the present invention, the purchaser gets his terminal close to the opponent's terminal, and the purchase process unit 140 of the terminal maintains communications with a nearby terminal by limiting the output of the transmission.

When the communication is made, the product data providing unit 120 of the terminal of the seller provides a product data stored in his memory to the terminal of the purchaser. In the terminal of the purchaser, the product data is provided to the user in the form similar with the product display screen of the online shopping mall by the purchase process unit 140. The purchase process unit 140 of the terminal of the purchaser selects a desired item from the user among the products and transmits a purchase request data to the terminal of the connected seller. The purchase request data includes a recognition data of the terminal of the purchaser and a product code of the product that the user wants to purchase.

The sale processing unit 130 of the terminal of the seller receives the purchase request data and processes the order. In an embodiment of the present invention, the terminal of the seller is connected with the WAP server 51 through the broadband wireless communication unit 310 and provides an order data including the product code and the recognition data of the terminals of the seller and purchaser to the WAP server 51 for thereby processing the order. The WAP server 51 processes the order and allows the item to be delivered to the purchaser. The above sale is processed as a sale performance of the seller.

The peripheral terminal inquiry unit 170 according to the embodiment of the present invention may be applied for different purposes irrespective of the transaction of the items. For example, in the case that the terminal according to the present invention is supplied to all persons, the presences of the persons who are positioned within a certain range may be checked. In the dangerous situations, the dangerous situation may be supplied to peripheral persons, so that a proper help can be obtained.

In another embodiment of the present invention, the peripheral terminal registration unit 150 receives the recognition data from the other terminal and stores into the third region of the memory together with the time data at the time when the recognition data are received. The peripheral terminal inquiry unit 170 outputs the peripheral terminal data stored in the third region of the memory by the recognition data receiving time. Here, the recognition data receiving time represents a time at the time when the terminal, requested the recognition data, receives the recognition data or a time at the time when the terminal providing the recognition data transmits the recognition data or may represents the time of receiving both the data. Even when it is commonly adapted to all the terminals, a proper timing may be set.

The terminal according to another embodiment of the present invention includes a GPS module 350 for receiving a navigation signal from the GPS satellite, and a position data computation unit 160 for computing the current position of the terminal from the signal received from the GPS module. In this embodiment of the present invention, the peripheral terminal registration unit 150 receives a recognition data from the other terminal and stores into the third region of the memory together with the position data of the terminal. Here, the peripheral terminal inquiry unit 170 outputs the peripheral terminal data stored in the third region of the memory 900 together with the position data of a corresponding terminal. For example, a map data may be stored in the memory 900, and the position data of the peripheral terminal and recognition data may be stored. In another embodiment of the present invention, the map data may be used at a certain region in which the peripheral terminal inquiry unit 170 inquires from the WAP server 51 through the broadband wireless communication unit 310. The thusly-obtained map data are displayed together with the recognition data of the peripheral terminal stored in the memory 900. In addition, the positions of the peripheral terminals may be displayed in the shape of a compass, not with the map data.

The terminal according to an embodiment of the present invention may further include a host sync process unit 110 which is connected with the WAP server 51 through the broadband wireless communication unit 310 in response to a sync event and transmits the recognition data stored in the third region of the memory 900 to the host computer together with the terminal recognition data stored in the first region for thereby separately managing the terminal recognition data in the WAP server 51.

The terminal according to the embodiments of the present invention further includes a verification process unit 210 for verifying the user in the electronic commerce or the personal data transmission and receipt. The verification process unit 210 checks the recognition data stored in the chip card and the password stored in the chip card. In another embodiment of the present invention, the terminal further includes a verification sensor 410 which receives a biological data of the user. For example, the verification sensor 410 may be a biological recognition sensor such as a fingerprint scanner, and an iris scanner. In this case, the verification process unit 210 includes an encoding and verification algorithm for a biological recognition so as to verify the user's status from the signal inputted from the verification sensor.

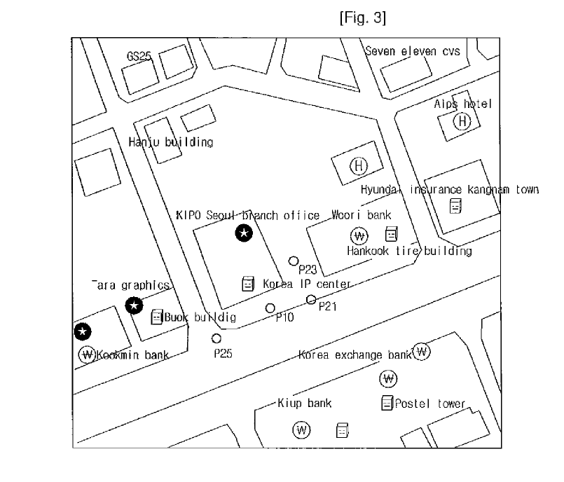

FIG. 3 is a view illustrating an inquiry screen displayed on the display unit 700. As shown therein, the positions P21, P23, and P25 of the terminals are indicated on the map near the peripheral portions of his terminal of P10. The measured date and time are displayed at the lower right side. The minimum data provided by the owner of terminal are provided when the icons of the positions are clicked. The above screen is provided when each terminal owner is connected with the web server 53 or the WAP server 51 using the personal computer 13 or the terminal 10-1. The terminal owner checks the open data and recognizes the opponents based on the position displayed on the map. If the opponent permits, it is possible to communicate with the opponent terminal or to send a message. In addition, in a crime situation, it is possible to find suspects who stay near the place. In addition, it is possible to check and contact the person who met in the past. Namely, various applications are possible. Here, multiple icons may be concurrently selected with one click.

The personal data transmission and receipt unit 190 continuously transmits his terminal recognition data, his position data computed by the GPS module 350 and the position data computation unit 160, and the time data, at the time when the position is computed, through the LAN wireless communication unit with reference to the timer 1100. The recognition data of each terminal, the position data of each terminal, and the time data, at the time when the position is computed, are continuously and periodically received from the other peripheral terminals, and the status diagram is created and displayed on the display unit. If necessary, the above data are stored in the memory 900.

The thusly-accumulated data may be very usefully used for various purposes. For example, when the use of the terminal according to the present invention increases, the suspects of the crimes may decrease by inquiring the peripheral terminals of a corresponding terminal at a corresponding time when a traffic accident or crime occurs. In addition, in the case that a friend registered in the terminal as a friend stays near his place, the presence of the friend can be effectively informed to the user.

According to the embodiments of the present invention, in the peripheral terminal registration unit 150, the recognition data of the terminal, which receives the initial recognition data, may be classified and stored separately from the recognition data of the other terminals which additionally receive the recognition data. The data may be stored in various types.

The above recognition data may be a data of recognition a certain terminal and may be a certain inherent number and may be a telephone number of the terminal and may be one businessman's inherent code. Namely, the above recognition data may be implemented in various types.

The above operation may be applied to various useful applications in an embodiment in which the recognition data is received only from the nearest terminal in a state that the transmission of the terminal is limited. Here, the user stores the recognition data of the opponent to which the data transaction is proposed for a meeting request, an emergency situation, a joint purchase, an item purchase, a reverse auction, a research, a road corporation service, etc. and stores the recognition data of the terminal, which has less attention, into the third region. With the above construction, it is possible to separately inquire the data. For example, it is possible to separately search the opponents that the user purchased the product or other data are communicated.

In the embodiment of the present invention, the terminal is further provided with an emergency alarm process unit 180 which is connected with the emergency contact stored in the memory 900 stored in the broadband wireless communication unit 310 in response to an alarm event and provides the data of the terminals stored in the memory.

In an embodiment of the present invention, the alarm event is a press event of the emergency. In another embodiment of the present invention, the alarm event may be an activation event of the impact detection sensor provided in the system. The emergency message may be provided in a multimedia text message provided through the broadband wireless communication unit 310. The protector registered as an emergency contact person may receive the message of a ward and recognizes the position and recognition data of the peripheral terminals from the message and may receive an additional data needed for the post-accident measurement.

In this embodiment of the present invention, the terminal may further include a camera unit 500 for photographing the images. The emergency alarm process unit 180 provides the images taken by the camera unit as an emergency contact method together with the data of the terminals stored in the memory 900 in response to the alarm event. The protectors registered at the emergency contact person receive the messages of the wards and obtain the data concerning the peripheral terminals and the images of the place.

For example, in the case that the terminal is the telematics terminal installed at a taxi, the taxi driver can effectively cope with any threat from the passenger using the telematics terminal according to the present invention. The current situations of the interior of the taxi are recorded in response to the emergency button press event of the taxi driver, and the taxi company or the police station is provided with the position and time and the recognition data of the terminals of the driver including the passenger, with the taxi company and the police station being registered as the emergency contact government offices.

In addition, the images of the camera unit 500 and the voices inputted through the microphone 314 are stored into the memory 900 for a certain time period and are used for evidences.

According to another embodiment of the present invention, the emergency alarm process unit is sequentially communicated with the peripheral terminal in response with the alarm event through the LAN wireless communication unit 330, with the recognition data being stored in the memory 900, so that the emergency help message stored in the memory is transmitted. In this case, it is possible to request a crime or an accident situation to peripheral persons.

According to an embodiment of the present invention, the terminal further includes a personal data transmission and receiving unit 190 which is connected with a first terminal among the terminals through the LAN wireless communication unit 330 in response to the user's operation, with the recognition data being stored in the memory 900, and with the personal data request signal being transmitted to the terminal, and with the personal data transmission and receiving unit 190 receiving the personal data of the owner of the terminal. At this time, the personal data may be a business name card data. In the terminal according to an embodiment of the present invention, the user allows the peripheral terminal inquiry unit 170 to check the statuses of the peripheral terminals so as to exchange the business name card with the opponents and allows one terminal of the multiple terminals to exchange the business name card data with the terminal or to transmit his business name card data or to receive the opponent's business name card data based on the agreement of the opponent.

According to another embodiment of the present invention, the personal data transmission and receiving unit 190 transmits a personal data request signal together with the personal data of the owner of the terminal stored in the memory. The above embodiment of the present invention may be effectively applied for the data used for a meeting with other persons who do not know each other. Namely, when a person meets an opponent attractive to him, the person proposes a data exchange to the opponent through the terminal rather than a conventional proposal method. The person may open a personal data of the opponent which is open to others and may carefully access the opponent. In the embodiment of the present invention, the personal data received from the opponent terminal may include a connection data concerning the personal data page of the opponent. The person may visit the personal homepage or blog which has the personal data of the opponent using the connection data for thereby having a cyber meeting. At this time, the personal data received through the terminal is limited to the data set to be open to others, with the data being included in the personal data of the opponent.

In the meeting method, it is possible to recognize the hobby, age, job, etc. of the opponent through the exchange of the personal data and continue to have a telephone communication or to have the meeting in a cyber space even when they have departed from each other at the place.

According to another embodiment of the present invention, the personal data transmission and receiving unit is connected with the WAP server 51 through the broadband wireless communication unit 310 in response to the user operation and transmits a personal data request signal of requesting the personal data of the owner of the first terminal among the terminals stored in the memory 900 and receives a personal data of the terminal owner and outputs the same. Namely, it is possible to exchange the personal data with each other through the host computer.

Here, the personal data may be a business name card data. Namely, in the terminal according to an embodiment of the present invention, the user allows the peripheral terminal inquiry unit 170 to check the statuses of the peripheral terminals so as to exchange the business name card with opponents, and allows one terminal to exchange the business name card data with the terminal through the WAP server 51 or transmits his business name card or receives the business name card data of the opponent based on the opponent's agreement.

According to another embodiment of the present invention, the personal data transmission and receiving unit 190 transmits a personal data request signal together with the personal data of the owner of the terminal stored in the memory 900. In this embodiment of the present invention, the personal data received from the server 50 may further include a connection data with respect to the personal data page of the opponent. It is possible to visit the personal home page or blog having the personal data of the opponent using the connection data and to have a cyber meeting. Here, the personal data received through the terminal may be limited to the data set to be open among the personal data of the opponent.

In the present invention, it is possible to continue communicating with each other on the phone or meeting with others in the cyber space even when they are departed from each other after they recognize the hobby, age, job, etc. of the opponent through the exchange of the personal data.

The terminal according to an embodiment of the present invention classifies and manages the data transaction log by the data. Namely, in the case that the recognition data of the peripheral terminals are collected according to the present invention, the collected data are classified into the log data such as collected time, position and recognition number, the data of the terminals based on the product transaction with other terminals, the peripheral terminal data recognized based on the emergency event such as a pressing event of the help button in the emergency situation, and the data of the opponent's terminal which transmits and receives the personal data. The classified data are sorted in the table. Therefore, the user can easily classify the terminals classified by the data and inquire the same. For example, the user inquires the list of the opponents who transacted the products and inquires the list of the transaction. In addition, it is possible to inquire the lists of the opponents who exchanged the business name cards. In this embodiment of the present invention, the data transaction logs are stored in the memory 900 of the chip card. The chip card may be read using an additional terminal such as a personal computer and may be inquired with a better user interface, so that the data are transmitted to other application programs and are used as the useful data.

The peripheral terminal registration unit 150 of the terminal according to the present invention receives and stores the recognition data from at least one different peripheral terminal through the LAN wireless communication unit 330 in response to the event. At this time, the data are stored into the third region of the memory 900 by the category. Here, the event category represents an event which is related with product sale, product purchase, emergency alarm, and personal data transmission and receiving, etc. for thereby causing the recognition data collection of the peripheral terminal or the data transaction. Here, the peripheral terminal inquiry unit 170 outputs the data of the peripheral terminals stored in the third region of the memory in response to an external request based on the data classification by the category.

The terminals may be provided with various modifications. If necessary, the elements of the controller 100 may be changed in various forms. The WAP server 51 and the web server 53 may be implemented with one server. The modifications of the above construction will be described.

Throughout the descriptions of the present invention, the similar elements may be given the same reference numerals.

The term comprises represents an open term so that the term does not exclude the elements but further include the elements otherwise there are not specific indications.

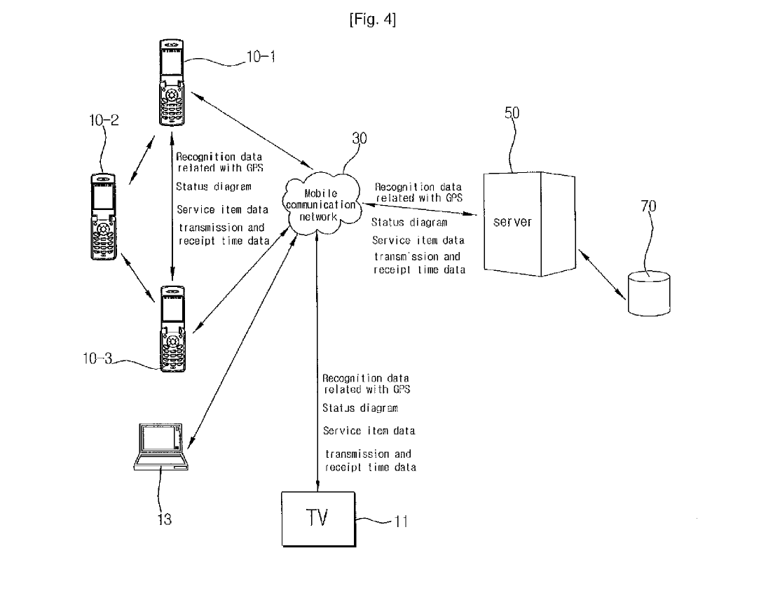

FIG. 4 is a schematic view illustrating a construction of a communication system including a terminal according to other embodiments of the present invention. As shown therein, the terminals 10-1, 10-2 and 10-3 according to the present invention performs wireless communications using at least one among a recognition data related with the GPS, a status data, a service item data, and a transmission and receipt time data. In addition, the terminals 10-1, 10-2 and 10-3 perform wireless communications using at least one among a recognition data related with the GPS through the server 50, a status data, a service item data, and a transmission and receipt time data. In particular, the user selects a service item data in the menu by operating the terminal and selects a desired service item among the service items for thereby executing various service items while seeing the status data or other screens.

If necessary, the television 14 or the terminal 13 displays a recognition data related with the GPS through the server 50, a status data, a service item data and a transmission and receipt time data. Here, the data may be classified into the recognition data, status data or service item data of the terminal of the family member. Here, the communication method may be either a wired method or a wireless method. The terminals according to other embodiments of the present invention may be connected with the server 50 through a network 30. The terminals 10-1, 10-2 and 10-3 may be various terminals such as a cellular phone, a notebook computer, a personal digital adaptor PDA, a desktop computer, etc. In the present invention, the terminals are not limited thereto. Namely, the terminals may be a telematics terminal or another type terminal.

The user is connected with the server 50 through the internet using another terminal 13. In the embodiment of the present invention, one server 50 is provided. If necessary, the servers may be combined or may become another server. The server may be divided into multiple servers.

The server 50 may be installed at a mobile communication service company or may be installed at a separate company. In the case that the server is installed at a separate company, the mobile communication company server may create a status diagram which represents a data including a position data of the peripheral terminal. The terminal may create a status data.

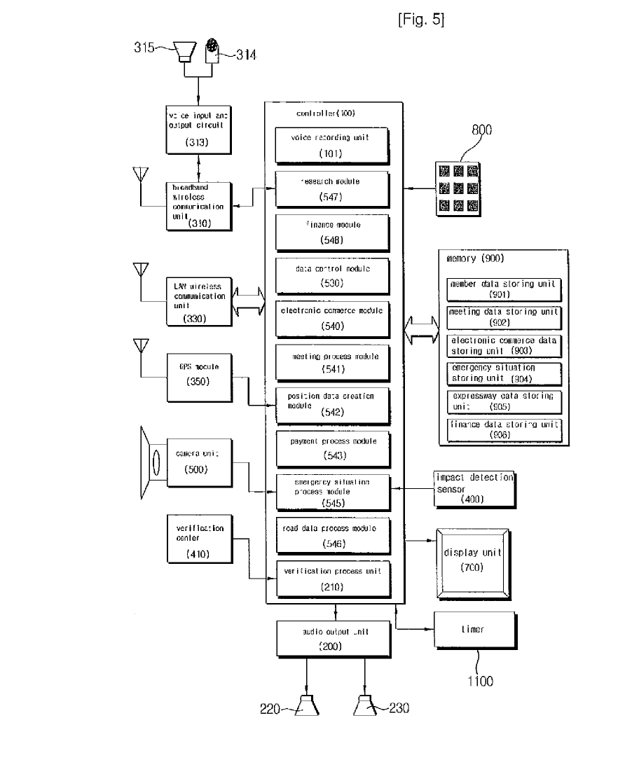

FIG. 5 is a schematic block diagram illustrating a construction of a terminal according to other embodiments of the present invention.

As shown in FIG. 5, the terminal according to the present invention is similar with the terminal of FIG. 2 except for the constructions of each terminal data and an internal data of the memory 900. In addition, the construction of the controller 100 is slightly different.

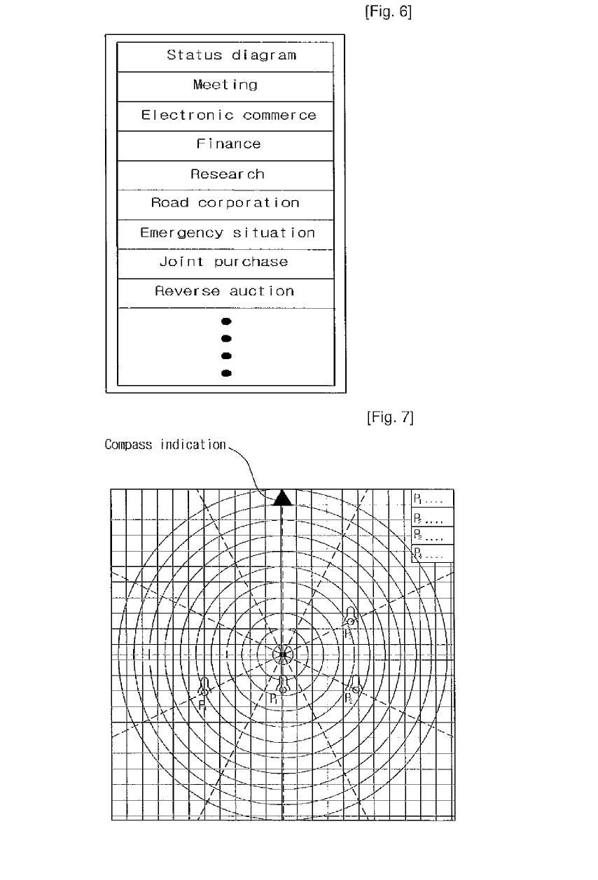

As shown in FIG. 6, the memory 900 includes a member data storing unit 901 for storing a personal data and a terminal data of a member of each terminal, a meeting data storing unit 902 for storing a meeting data such as a member photo, a body data, a job data, etc. for a meeting, an electronic commerce data storing unit 903 for storing a data of a product by the members for an electronic commerce, an emergency situation data storing unit 904 for storing the data of an emergency contact person corresponding to the member during an emergency situation and a government office, an expressway charge data storing unit 905 for storing an expressway charge of a road corporation, and a financial data storing unit for storing financial data of each bank and credit card data.

The member data storing unit 901 of the memory 900 may store a personal data of a member of each terminal and a terminal data and may request the data to the server 50. In necessary, it may store his data in minimum. The meeting data storing unit 902 may store a meeting data such as photos, body data and job data of members for a meeting and may receive the above data from the server 50. In the case of the meeting, minimum data may be stored or omitted. The electronic commerce data storing unit 903 may store the data of the product by each member for an electronic commerce and may receive and store the data from the server 50. If necessary, only his product data may be stored. The emergency situation data storing unit 904 stores the data of the emergency contact persons and government office corresponding to the members during the emergency situation. The expressway charge data storing unit 905 stores the expressway charge data of the road corporation and if necessary stores traffic data or other data.

In addition, the controller 100 includes a data control module 530 which controls the data transmission and receipt with respect to a plurality of terminals and controls the processes of a service item data including a meeting, electronic commerce, joint purchase, data related with emergency situation, research, finance, and reverse auction which are inputted from the input unit 800, a position data creation module 542 for creating a status diagram which represents the status of terminals positioned near a corresponding terminal in accordance with the position data and recognition data from the terminals 10-1 through 10-3, a meeting process module 541 for processing meetings, an electronic commerce transaction module 540 for processing an electric commerce, an emergency situation data storing unit 904 which informs the emergency contact person registered in the emergency situation data storing unit 904 of the emergency situation when a data informing of an emergency situation is received from the impact detection sensor 400, a road data process module 546 for providing an expressway charge data and transmitting a data of a destination and departure place and a payment data to the server 50, a payment process module 543 for processing payment, a research module 547 for performing a research and a finance module 548 for controlling a financial transaction.

As shown in FIG. 5, the recognition data related with the GPS or the service item data is selected by operating the keypad 800 of the terminal. When a key is inputted so as to recognize the recognition data related with the GPS of the peripheral terminal, the controller 100 creates the status diagram, which shows a recognition of the position data of the peripheral terminal, and displays on the display unit 700. At this time, a transmission and receiving time data may be included into the service item data, recognition data or status diagram. As shown in FIG. 7, an imaginary image is formed at the positions P1 through P4 formed at the portion near the terminals 10-1 of the center at the coordinate of the status diagram screen, and the terminals that the user wants to select among the terminal 10-1 at the imaginary images are selected. The position data and recognition data of the peripheral terminals including the selected imaginary images are indicated in a type of list, and the list type may include numbers or various data.

The status diagram may include a recognition data related with the GPS or list, and service item data of the terminal 10-1 or may include a recognition data of the destination terminal and the selected service item data and the transmission and receiving time data if necessary.

Here, the status diagram may include a service item data, a recognition data, a peripheral terminal position data or transmission and receiving data or may include the same independently.

At this time, the necessary data needed for the terminal of the selected imaginary image may be exchanged.

The above-described principle is adapted to the following descriptions and may be modified if necessary.

The operation of the terminal having the above-described construction will be described.

When a user selects a service item data using the keypad 800, the display unit 700 displays the service item data of FIG. 6 in accordance with a control of the data control module 530. Here, the service item data may comprise various items such as a finance, research, electronic commerce, meeting, road corporation, emergency situation, joint purchase, reverse auction, etc. The above service items may be created by the terminal manufacturer limitlessly if necessary or may created limitlessly if the server needs.

In this state, the user of the terminal selects a desired service item data among the service item data using the keypad.

For example, when the user selects the status diagram, the position data creation module 542 creates the status diagram which represents the statuses of the terminals positioned at a peripheral portion based on the GPS-related recognition data and position data externally inputted from peripheral terminals and displays the created data on the display unit. FIG. 7 shows the above status diagram.

As shown in FIG. 7, a corresponding region is divided in the vertical and horizontal directions in the status diagram, and the divided region is divided into a circular shape with respect to the center portion. The positions P1 through P4 of the peripheral terminals are expressed in imaginary images with respect to the center which corresponds to his position. When the imaginary image is selected, the status diagram data of the coordinate on the liquid crystal screen related with the GPS of each terminal and the list of the numbers near the center point are displayed on the liquid crystal screen. The recognition data and the simple recognition are displayed on the right in a form of list. When the imaginary image is pressed, the controller 100 may transmit at least one among the service item data, recognition data, and transmission and receiving time data to the server 50 or the terminal corresponding to the imaginary image.

Here, the status diagram may be modified into various types. The region may be divided into vertical and horizontal display regions, and various angles are indicated with a distance computation automatic analysis coordinate so as to recognize the position data of the coordinate of 12 angle sections, 24 angle sections, 48 angle sections, 120 angle sections or more angle sections at the divided regions. The positions of the wireless terminal or peripheral wireless terminals may be indicated within a circular range.

As shown in FIG. 7, the positions P1 through P4 of the terminals are indicated at the peripheral portions of his terminal, and the compass may be indicated at the upper side so as to indicate the north. As the terminal moves, the compass indicates the north, and the data of the status diagram and the list may be set in a sequence of the terminals which are near the center portion. When a certain key is inputted, the GPS-based status diagram data are formed as imaginary images on the status diagram indicated on the GPS recognition unit radar of the liquid crystal screen, and the list numbers are checked. When the imaginary image is pressed, various data including the recognition data of the list may be obtained. This data may he transmitted to or received from the server 50 or other terminals or may be stored in the memory 900.

The date or time that the status is checked may be indicated at the right side if necessary. The data opened by the owners of the terminals may be displayed at the right side in minimum size in a form of list. When a corresponding icon is clicked, the detailed data may be provided or the detailed data may be requested. When the owners of terminals are connected with the server 50 using the personal computer 13 or the terminal 10-1, the contents of FIG. 4 may be provided or may be directly requested to the other terminal. The owners of the terminals check the open data and recognize the opponent with reference to the position. If the opponent allows or after an opponent's allowance is requested, the service item is selected, and the data are exchanged, and the charge of the data exchange is paid, so that it is possible to communicate in voice or transmits and receives messages.

The display types of the display unit 700 may be modified into various types. The compass may be set to indicate the east, the west or the south, not the north. The recognition data may be a data with which the terminals can be recognition in relation with the GPS and may be an inherent number provided if necessary or may be a telephone number of the terminal or a verification number provide by a certain organ or may be a business registration number.

Seeing the status diagram, the user selects a certain opponent by operating the keypad 800 so as to request a meeting among the service items.

In accordance with a control of the data control module 530, the meeting process module 541 transmits a recognition data related with his GPS, a service item data, and a certain text or voice message so as to propose a meeting to the selected opponent. With the above procedure, a corresponding procedure is performed as the opponent permits or does not permits. The detailed descriptions of the meeting will be described later when it is described with reference to the server 50.

The user selects the opponent by operating the keypad 800 and selects a desired electronic commerce while seeing the status diagram or among the service item data with respect to a corresponding opponent.

The electronic commerce module 540 transmits a recognition data related with his GPS, a service item data or a text or voice so as to propose an electronic commerce to the selected opponent in accordance with a control of the data control module 530.

When the opponent receives the above proposal and provides his product data, and the payment module 543 pays the same for thereby finishing the electronic commerce. The detailed descriptions of the electronic commerce will be provided later when it is described with reference to the server 50.

When the user selects the emergency situation by operating the keypad 800 while seeing the status diagram or on the service items, the emergency situation process module 545 informs the emergency contacts stored in the emergency situation data storing unit 904 of the emergency situation.

The images and voices inputted from the camera unit 500 and the voice input unit 314 are stored into the emergency situation data storing unit 904 and are transmitted to the emergency contacts together with the status diagram data.

Here, the emergency contact may be a television 14, so that it is possible to view the status diagram, image and voices of the family on the television 14.

In addition, the detailed procedure of the emergency situation will be described later when the server 50 is described.

When the user selects a road corporation by operating the keypad 800 while seeing the status diagram or on the service item data, the road data process module 546 receives a destination and departure data, reads the charge data from the expressway charge storing unit 905 and provides the charge corresponding thereto. The payment process module 543 pays the charge in association with an external bank server or the server 50. When the payment is finished, the road data process module 546 informs the server of the road corporation of a vehicle data, destination, departure, payment data, etc. The detailed description of the expressway charge process will be described later when describing the server 50.

When the user selects a research by operating the keypad 800 while seeing the status diagram or on the service item data, the research module 547 transmits a text or voice of requesting an election candidate preference based on the ages, sexes, regions, etc. stored in the member data storing unit 901 to the terminal of each member. The obtained data are usefully used for the election based on the ages, sexes and regions, so that the preference of the election candidate can be easily judged. The poll trend survey can be easily performed with the above preference.

When the user selects a finance while seeing the status diagram or on the service item data using the keypad 800, the financial module 545 indicates each bank and credit card company data stored in the financial data storing unit 906, so that the financial transaction of the selected bank or credit card company is performed.

In addition, the user can select the bank or credit card company with voice or text input, and the bank account or menu may be selected while seeing the credit card number of the credit card company or the bank account or the menu, so that the financial transaction is performed. In addition, the integrated financial transaction process may be performed with the voices or texts if necessary.

When the card reader is provided in relation with the terminal for thereby reading the card, and the financial service is selected with the voices and texts, it is possible to select a desired bank or credit card company. Here, when a corresponding bank is shown, and a financial data of a member is outputted, the biological password is inputted using the verification sensor 410. When the bank account data is outputted, the financial transaction can be performed.

The detailed financial procedure will be described later when describing the server 50.

The internal elements of the controller 50 may be implemented with software or hardware. Various additional elements may be provided thereto for various services. It may be implemented with only one controller 100. For simplification, only part of the elements is shown. The construction is not limited thereto. In this embodiment of the present invention, the memory 900 is divided into multiple regions, but it may be implemented with only one memory.

With the terminal, it is possible to perform a meeting request, an emergency situation data, a joint purchase and an electronic commerce with other terminals. It may be performed through the server 50.

The creation of the status diagram will be described in detail with reference to FIG. 7.

The user may select a service item or a status diagram or may indicate only the status diagram. So as to create the status diagram, the position data creation module 542 receives its position data from the GPS module 350.

In addition, the data including a latitude and longitude from the peripheral terminal and the recognition data of a corresponding terminal are received and combined with its position data, so that the status diagram of FIG. 7 is displayed on the display unit 700.

If necessary, the position data and recognition data related with the GPS base station may be requested to the peripheral terminal through the LAN wireless communication unit 300 or the broadband wireless communication unit 310, and the position data, recognition data and transmission and receipt time data may be received at time intervals.

The position data creation module 542 is formed of a compass which indicates the north.

The position data of each terminal is formed at the coordinate of the status diagram, and an imaginary image is formed at the portion of the peripheral terminal from its position formed at the center of the screen. As the imaginary image is selected by the keypad 800, the data exchange is performed through the selected terminal.

The position data creation module 542 indicates the latitude and longitude data with certain scales when its own terminal and peripheral terminal are indicated with their positions. The distance is expressed with a concentric circle.

The creations of the status diagram may be performed in various shapes. The technology of using the server 50 as a medium will be described.

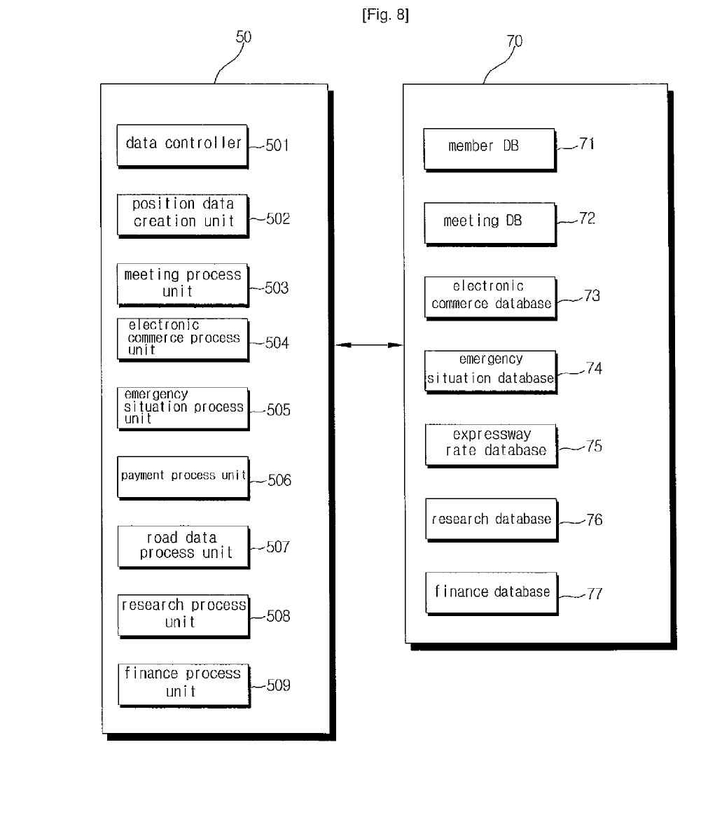

FIG. 8 is a view illustrating a construction of a data exchange system according to an embodiment of the present invention.

As shown therein, the data exchange system according to an embodiment of the present invention includes a server 50 and a database 70. If necessary, a sever 50 may perform the function of the web server 53.

Here, the database 70 comprises a member database 71 for storing a member's personal data and terminal data, a meeting database 72 for storing a meeting data such as a photo, body data and job data of a member for a meeting, an electronic commerce database 73 for storing a product data by each member for an electronic commerce, an emergency situation database 74 for storing an emergency contact and government office data corresponding to a member in case of emergency situation, an expressway charge database 75 for storing an expressway charge data of the road corporation, a research database 76 for storing a research data, and a financial database 77 for storing the data of a bank and a credit card company and a transaction data.

The server 50 includes a data controller 501 which controls the transmission and receipt of the data with the terminals 10-1 through 10-3 and controls the processes of a meeting, electronic commerce, joint purchase, emergency situation data, research and financial data inputted from the terminals 10-1 through 10-3, a position data creation unit 502 which creates the status diagram showing the statuses of the terminals near a corresponding terminal in accordance with the position and recognition data inputted from the terminals 10-1 through 10-3, a meeting process unit 503 which processes the meeting, an electronic commerce process unit 504 which processes an electronic commerce, an emergency situation process unit 505 which inform an emergency contact of a corresponding terminal of an emergency situation when the data of the emergency situation is inputted from the terminals 10-1 through 10-3, a road data process unit 507 which provides an expressway charge data and informs the road corporation server 1200 of the transaction data, a payment process unit 506 which processes payment, a research process unit 508 which processes research, and a financial process unit 509 which processes financial data. The internal elements of the server 50 may be implemented with software or hardware if necessary. Various elements may be provided so as to implement various services. Only one controller 100 may be provided for controlling the above operations. For simplification, part of the elements is shown in the above. The above construction is not limited thereto.

The operation of the data exchange system according to an embodiment of the present invention will be described.

FIG. 9 is a flow chart of a data exchange system according to an embodiment of the present invention.

As shown in FIG. 9, the server 50 and the wireless terminals 101 and 102 may communicate data in various methods. If necessary, the data exchange methods may be changed into various methods. In the present invention, only two terminals 10-1 and 10-2 are adapted for simplification, but the number of the same is not limited thereto. Namely, more terminals may be adapted.

As shown in FIG. 9, the terminal 10-1 requests data to the other terminal 10-2 and receives the data and directly processes the data and informs the server 50 of a result of the process. The server 50 stores a result of the data exchange into the database 70 and informs the terminal 10-2 of a result of the above process. The data transmitted from the server 50 to the terminal 10-1 may include at least one data among the recognition data related with the GPS, the service item data, the status diagram data, and the transmission and receipt time data. If necessary, the server 50 may transmit a price list, which is a payment data, to the terminal 10-1. The terminal 10-1 matches the data with the data stored in the server 50 after the data are received or the payment is performed and transmits a list data with respect to a result of the connection to the terminal 10-2.

If necessary, the terminal 10-1 may inform the terminal 10-2 of one data among the recognition data related with the GPS, the service item data, the status diagram data, and the transmission and receipt time data and may transmit the service item data, which is a request data, to the server 50. The terminal 10-1 may receive a data concerning the service item data from the server 50 and may process the same. In addition, the server 50 stores a result of a corresponding data exchange into the database 70, and a result of the process is informed to the terminal 10-2.

In another method, the terminal 10-1 requests a data to the terminal 10-2, and the terminal 10-2 inform the server 50 of a requested data, and the server 50 provides a corresponding data to the terminal 10-1.

In further another method, the terminal 10-1 collects a data concerning the terminal 10-2 in the server 50 when the terminal 10-1 knows the data of the terminal 10-2 and exchanges a corresponding data, and the server 50 inform the terminal 10-2 of a result of the process.

In still further another method, when the terminal 10-1 requests a data to the server 50, the server 50 informs the terminal 10-2 of a state that the server 50 requests a corresponding data, and the terminal 10-2 provides the terminal 10-1 with a corresponding data.

There may be various exchange methods. The data exchange may be performed only between the terminals or may be performed together with the server 50.

The server 50 may provide the status diagram data to the terminal 10-1 which requests the data or the terminal 10-1 may directly receives the position data from the other terminals 10-2, 10-3, . . . , so that a data list of the peripheral terminal may be created when the imaginary image of the position data is selected by displaying the position data from the recognition data related with the GPS of the member stored in the terminal.

Here, the terminal 10-1 may requests a position data obtained using a GPS module, a recognition data, a service item data as well as a status diagram data and may request the service item after the recognition data and status diagram data are requested. Various modifications may be possible.

The above data exchange methods may be changed into various methods. Only the terminal to 10-1 or 10-2 may be adapted without the server 50, or the above methods may be implemented together with the service which is separately provided.

If necessary, the terminal 10-2 operates as a repeater or a server.

The server 50 may perform a data exchange of matching the data with its data by transmitting the data to the terminals 10-1 or 10-2 by force.

Here, the terminal 10-1 may perform a data exchange with the terminal 10-2 by force, and the terminal 10-2 matches the exchanged data with the data of the server 50, and the server 50 may match the exchanged data with the data of the terminal 10-1.

The server 50 may exchange the recognition data, transmission and receipt data, service item data and status diagram data through the television, AP, terminal, e-mail, blog, homepage, etc. of the registered member and may store the same into the memory, with the stored data being used as an evidence material.

The data exchange method between the server 50 and the terminals 10-1 and 10-2 will be described in detail by each service item data.

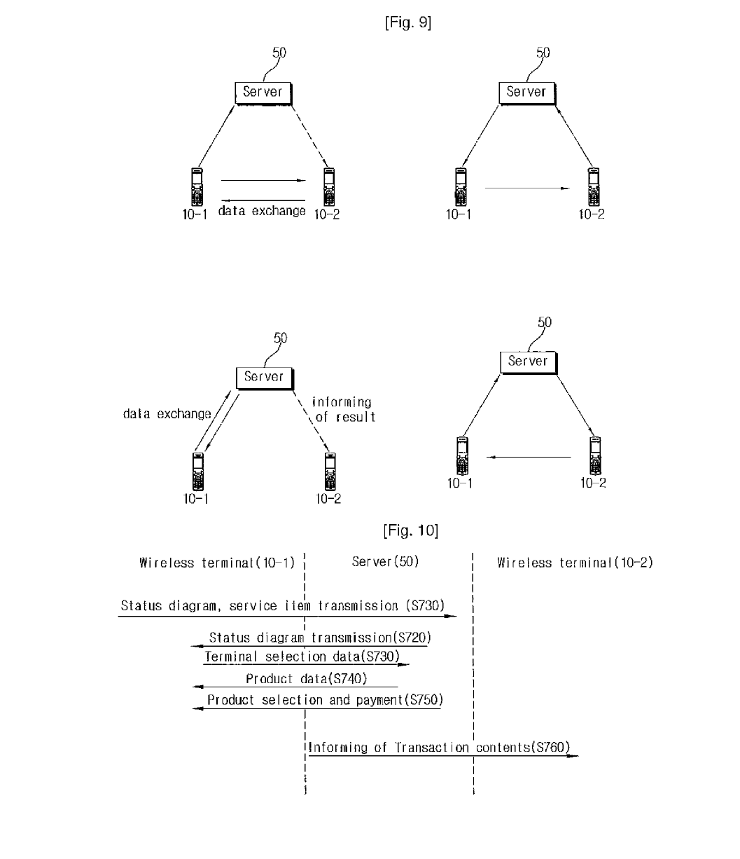

FIG. 10 is a flow chart when an electronic commerce service item data is selected in the data exchange system according to an embodiment of the present invention.

The user of the terminal 10-1 selects a menu by operating his keypad 800. When the service item data is selected, the controller 100 allows the service item to be displayed on the display unit 700.

Here, the service items displayed on the display unit 700 are electronic commerce, meeting, emergency situation, road corporation, research, joint purchase, reverse auction, finance, status diagram, etc. Here, the status diagram may be first selected or may be selected after or before the other service is selected.

Other service items such as business name card, integrated IC card, etc. may be added limitlessly. All services of using the terminals under the current environment may be added. Here, the terminal and server 50 should be previously provided with the data needed for a corresponding service in the memory 900 and the database 70.

When the status diagram data is selected after the electronic commerce is selected, the controller 100 of the terminal requests a status diagram based on the service item data together with his recognition data to the server 50 through the broadband wireless communication unit 310 in a step S710. Here, if necessary, the controller 100 may directly create the status diagram using the data of other terminals. The peripheral terminal inquiry unit 170 of the controller 100 performs the above process. Various modifications may be possible for the same purpose. Since the elements of the controller 100 have been already described earlier, the detailed descriptions will be omitted. Namely, the operation of the controller 100 will be described.

The position data creation unit 502 of the server 50 combines the position data of the terminal 10-1, which requests a status diagram, with the position data of the other terminals 10-2, 10-3, . . . , positioned within a certain distance and creates a status diagram and transmits to the terminal 10-1. At this time, the server 50 receives the position data of each terminal computed by the GPS module 350 and the position data computation unit 160 of each terminal 10-1, 10-2, 10-3, . . . , if necessary or at a certain time interval and stores the received data into the database 70. The server 50 creates a status diagram data using the stored data or transmits to the terminal 10-1 though the mobile communication network 31. Here, when the server 50 is not provided in the mobile communication service company, the operation of the position data creation unit 52 may be requested to the mobile communication service company for thereby receiving a status diagram, with the received status diagram being transmitted to the terminal 10-1.

The terminal 10-1 displays the status diagram data received through the broadband wireless communication unit 310 on the display unit 700 in accordance with a control of the controller 100. The distance and direction from the radio received from other terminals are computed and included in the status diagram data, so that the position of the terminal can be indicated. The positions of the terminals may be indicated on the status diagram data by detecting the type of radar. The detailed data of a corresponding terminal may be viewed by selecting the indicated imaginary image.

The user selects a desired destination terminal among multiple terminals indicated on the status diagram.

In the case that the selected terminal is the terminal 10-2, the controller 100 transmits a data that the terminal 10-2 is selected and requests a data of a corresponding terminal to the server 50 in a step S730.

The electronic commerce process unit 504 of the server 50 transmits a product data of the terminal from the electronic commerce database 73 to the terminal 10-1 in a step S740.

The product data and price are displayed on the display unit 700 of the terminal 10-1, so that the user orders a desired product. The payment process unit 506 performs payment. Here, the payment may be finished in various methods such as a credit card payment, payment by money transfer, etc. The verification procedure for the payment may be performed in various methods such as biological verification, fingerprint verification, iris recognition, password number, vein recognition, etc. in a step S750.

The server 50 may provide the transaction list to the destination terminal 10-2 and may distribute profits later with respect to a result of the transaction.

Here, the electronic commerce may be performed between the terminals, and only the payment and transmission of a result of the same may be performed in the server 50.

The electronic commerce is provided with an evidence material and a basic material by which an order payment is easily performed, which may be adapted to an advertisement sale network reverse auction, a customized advertisement sale joint purchase, etc.

For example, in case of the joint purchase, when a first-year high school student requests a joint purchase with respect to English book on the server, the server transmits a joint purchase list to the member of the first year high school students registered in the server member list and receives the orders from each terminal member. Here, the English book may be bought for 5000 won (10% of 10,000 won) based on the number of students. When the advertisement is outputted, the server 50 receives money from an item sale company. When the advertisement is outputted with the lists of positions of old and student persons or the list sorted by sex, the purchased amount of the advertisement sale items may be ½ or ⅓ based on the number of purchasing customers who press the purchase button.

In the case of the reverse auction, the terminal member requests a purchase on the server 50, and the server 50 transmits a corresponding purchase data to a plurality of sale members, so that the sale member who provides at lowest price can be connected.

The items or preferences may be classified by members based on the seasons, spring, summer, fall and winter, and the connection charges may be requested for the collection of data. The above examples may be modified in various types and may be provided for free.

The motion pictures and voices of the sale member searched using the PDA, computer, cellular phone, wireless terminal, remote controller or bar code unit or wired telephone may be transmitted to a certain channel of a television or a wireless terminal or PDA, so that the received motion pictures and voices may be edited.

In addition, in the electronic commerce of the service items, the terminal and identification numbers of other terminals are not changed even when a certain item is stored in a database. The identification code or item inherent number is formed of an inherent number of a manufacturer and an item inherent number. Though the manufactures are same, when the colors and designs are changed with respect to a single item of poly 20% and pure cotton 80%, the same item inherent numbers may be given. For example, in the specification of the basic item inherent number, when the color of the cloth formed of poly 20% and cotton 80% is one among red, red-yellow, yellow, green, blue, dark blue, violet, assuming that one color and design is fabricated with 0Δ∇□⋄ with a sequence of red, red-yellow, yellow, green, blue, dark blue, violet, certain numeral numbers may be provided like the design of 0Δ∇□⋄ is provided to the red color 001, and the design of 0Δ∇□⋄ is provided to the red yellow 001 in the method for providing item inherent numbers. The design is provided with 0Δ∇□⋄ so that the color and design are changed and ordered. Therefore, various selection orders are possible in the present invention.

In addition, each item order is performed with a database list by which order is performed on the server 50. In the case of different items or colors even in event of same manufactures, different item inherent numbers or recognition codes may be provided. One among the seller, purchaser, fabrication delivery terminal or server may be matched with the entire data.

The item data may be adapted to a data exchange of the service item data of each member registered in the server related with the terminal recognition number. The data such as an inherent code, which is a terminal recognition number, a member data, an item inherent code, an item image, a design, a color, a size, etc. may be stored in the exchange data of the service item data.

Here, the seller of items may be a manufacturer, and the manufacturer may be a seller. The person himself may fabricate and sell the item and may become a purchaser with respect to a certain item. Namely, the purchaser may be a manufacturer with respect to a certain item or a seller. With respect to the item delivered after the order and payment, the purchaser collects a data from a wireless terminal or receives a list data from the server 50 and makes a signature for a confirmation of the receipt. Here, the server, purchaser, manufacturer and seller may input the same data into their wireless terminals.

The operation when the user selects a meeting service item data will be described as follows.

The operation when the user selects a meeting service will be performed as follows.

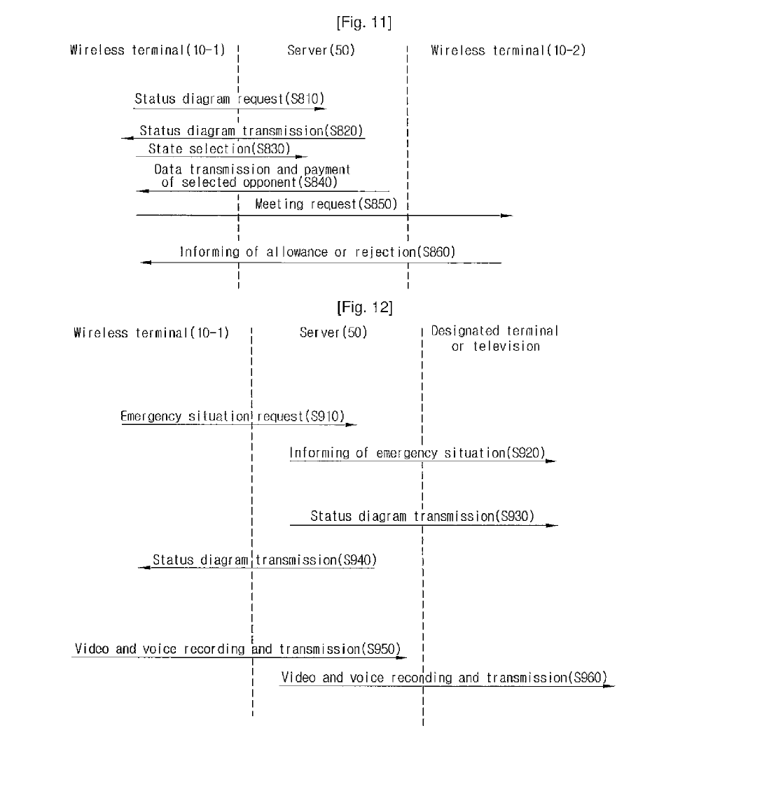

FIG. 11 is a flow chart of a data exchange system when a meeting service is selected among the services.

First, the user of the terminal 10-1 selects a menu by operating his keypad 800. When the service item is selected, the controller 100 displays a service item on the display unit 700.

When the user selects a meeting service and then a status diagram, the controller 100 of the terminal requests a status diagram to the server 500 based on the service item in a step S810. At this time, if necessary, the controller 100 can directly create the status diagram using the data of other terminals.

The position data creation unit 502 of the server 50 collects the position data of other terminals within a certain distance range from the position data of the status request terminal 10-1 based on a result of the data controller 501 and transmits to the terminal 10-1 in a step S820.

The terminal 10-1 displays the status diagram data on the display unit 700, and as shown in FIG. 7, a status diagram of other type is shown.

The user selects a certain destination terminal 10-2 among the multiple terminals 10-2, 10-3, . . . , displayed at the status diagram.

In the case that the selected terminal is the terminal 10-2, the controller 100 requests a selection data to the server 50 in a step S830.

The meeting process unit 503 of the server 50 transmits the meeting data of the terminal 10-2 from the meeting database 72 to the terminal 10-1. At this time, since the owner data of the terminal 10-2 includes a photo, etc., it is needed to pay or to make a certain agreement on the use of photo in a step S840. If necessary, the above payment or agreement may be omitted.

The data including an opponent's photo, etc. is displayed on the display unit 700 of the terminal 10-1.

In this state, the user fills out a date request form using the keypad 800 or the user records a voice. The controller 100 transmits the requested content to the terminal 10-2.

The owner of the terminal 10-2 allows or rejects the date request. If allowed, the date is performed.

The date request content and a result of the same may be stored in the wireless terminals 10-1 and 10-2 or the database 70 of the server for the use later.

When the date is requested, the requester's data and date request content are transferred. The contents of the same may be used as a material for a movie or soup review.

If necessary, the allowance or rejection state of the terminal 10-2 may be inquired. In this case, the server 50 may transmit the data of the member of the terminal 10-2 to the terminal 10-1.

The terminal 10-1 may send a certain data formed in a shape of heart or formed with a certain melody to the opponent. When the owner of the opponent terminal allows, the attractive points or allowance reasons may be transmitted with voice or text symbols designed so as to match with the attractive points.

When the opponent rejects, the transmission and receipt are no longer performed. In this case, since the status diagram with the date request inherent number is stored, it is possible to prevent any stoking behavior. Namely, when the opponent rejects the request of date, since the inherent number of the terminal of the requester is stored in the server 50 or the opponent's terminal, it is possible to basically prevent any stoking behavior with the evidence stored.

At this time, the owner matching procedure, fingerprint recognition procedure, iris recognition procedure and vein recognition procedure may be performed with respect to every terminal. Therefore, only when the person is verified, the data are transmitted or received. When the date request is continuously performed after rejections, a certain alarm message may be sent using the above data or a call may be made to the police. Regarding the profits, a date request is inputted into the server 50 or the wireless terminal 10-1, a registration rate may be charged when a member is registered or a certain amount of connection rate may be charged whenever a connection is made.

The connection charges and connection rate may be determined based on the references of the server 50 or the mobile communication service company or the wireless internet service company.

The above processes may be modified into various methods. When the service item is selected after a meeting selection or key is inputted into the terminal 10-1, the imaginary image is selected while seeing the status diagram and list. The data are directly transmitted to the terminal 10-2 or the server 50. The server 50 may transmit the data of the terminal 10-1 to the selected terminal 10-2 based on the meeting which is a service item. In addition, the server 50 may transmit an allowance or rejection data to the terminal 10-1 based on the data.

The purpose of date request may be different based on the types of requesters. Namely, the purposes may be changed based on a geometric reason, a positional state, an attractive point, a style similar with a soup star, so that the requester may want to perform the soup. When the date is requested, a movie or soup replay may be requested. In this case, upon careful review, the opponent may allow the date request. A romantic date may be replayed like a movie or a soup.

The data of a favorite style opponent may be previously stored into the database 70 through the server 50 or may be stored into the terminal 10-1, 10-2, 10-3, . . . , so that the preferences may be determined by the terminals in percentage.

With the above construction, the owner of the terminal can request a date while checking his favorite opponents with the preferences of 100%, 90%, 80%, 70%, 60%, 50%, 40%, . . . 10%. In the case that there are not date opponents between the preferences of 100% and 50% at a certain place, the owner of the terninal can select a certain date opponent in the downward search and can download the opponent's data. The date may be selected based on the requester's style. When an owner of the terminal classifies his preference into an art field, a literate field, a sports field, a movie field, an outdoor soup field, a drink and entertainment field, it is possible to request a date with the above his preference.

When there are not date opponents in the above fields, the date request may be performed in the downward search from the preference of 100%. In this case, the date may be achieved any time. Here, the terminal or server 50 stores the database 70 classified with trend, hobby, desired style, etc. in percentage. In addition, the partners may be formed in a form of a list, and the list is stored in the memory 900 of the terminal or the database 70. The preferences are determined in percentage based on the selection reference in a personal partner list.

In addition, when a movie or soup replay with the date requester is requested during the above process, a major scene of the movie or soup is proposed, and the texts and scenes are displayed through the terminals 10-1 and 10-2, so that the replay is performed. The movie or soup may be previously stored in the terminals 10-1 and 10-2 or the database 70.

For example, the server 50 may send a good scene of a soup drama to the terminals 10-1 and 10-2 and displays the same.

FIG. 12 is a view illustrating an operation when an emergency situation occurs when a user selects an emergency situation on the service items or a certain impact

As shown therein, the user of the terminal 10-1 selects a menu by operating his keypad 800, and the controller 100 displays the selected service item on the display unit 700 when the user selects the service item.

At this time, the menu displayed on the display unit 700 is an electronic commerce, a meeting, an emergency situation, a road corporation, a research, a joint purchase, a reverse auction, a financial transaction, a status diagram, etc. Here, the status diagram may be selected before or after the other service is selected. If necessary, the above process may be omitted. As described earlier in the description of the terminal, when a certain impact is applied to the terminal 10-1, the impact detection sensor 400 detects the impact. The controller 100 informs the server 50 of the emergency situation. At this time,

If necessary, the emergency situation may be classified into an emergency situation in which the impact is applied to the terminal and an emergency situation occurring based on the user's selection. The above two different emergency situations are differently measured in a step S910. If necessary, the image data of the camera unit 500 or the voice of the voice recording unit 101 may be transmitted together.

The position data creation unit 502 of the server 50 collects the position data of other terminals 10-2, 10-3, . . . , positioned within a certain range from the position data of the status diagram request terminal 10-1 based on a request of the data controller 501 and creates the status diagram and transmits to the terminal 10-1 and the peripheral terminals 10-2, 10-3 for thereby informing them of the emergency situation.

The emergency situation process unit 505 transmits the status diagram to the emergency contacts stored in the emergency situation database 74 and inform them of the emergency situation in steps S920 and 930.

Each terminal 10-1, 10-2, 10-3 displays the status diagram data on the display unit 700, records the images and voices inputted from the camera unit 500 and the microphone 314, and transmits to the server 50 in a step S950.

The emergency situation process unit 505 of the server 50 stores the received images and voice data into the emergency situation database 74 and transmits to the emergency contacts.

At this time, a person or a user of the peripheral terminals 10-2, 10-3 who receives the emergency situation message may repeat to the police station, police car, etc. Only the status diagram of the person who received the emergency situation is transmitted to a corresponding government office. In necessary, his own data or position data may be transmitted. Here, the position data list, GPS related list, status diagram list, service item data, transmission and receipt time data, etc. may be transmitted. The emergency contact may be the police station, fire station, etc.

The status diagram, images and voices stored in the terminal or the database 70 may be used as evidence materials later.

The terminal for status diagram may be installed at a certain place. The installation places may be many different places. The above terminal 10-1, 10-2, 10-3 may be installed at a traffic signal lamp of a road side, controller, electric transformer, electric cable, CCTV, interphone of home, power, gas or water meter of each building, power meter box, electric pole, high voltage cable, tollgate detector, vehicle telematics detector, etc. for thereby collecting status data.

The status diagram shows terminals in certain directions. A compass having the east, west, south and north indications may be installed at the status diagram. In necessary, various data may be further included.

The direction of the wireless terminal may be set. The faces of the opponents are pictured in certain directions so as to set the directions of the owners of the wireless terminals except for the compass. As the radio generation (transmission) coordinate of the wireless terminal 10-1 and the radio receiving coordinate of the wireless terminal 10-2 are set, the direction of the current transmitter and the terminal direction of the receiver may be set.

When the telematics terminal is used as the terminal 10-1, and vehicle collide with each other, the running direction of each vehicle and the images and sounds at the time when the accident occurs are recorded. The reasons of the accident may be found using the data of the passenger's terminals of each vehicle. In addition, it is possible to compute the entire distance, collision strength, and running speed of the vehicles based on a triangle computation method or a certain computation method using the transmission time, receiving time of the collision time and the position of each terminal when the vehicles collide with each other. In addition, the above data may be used as evidences for the traffic accident so as to prevent any conflicts by providing the above evidences to insurance companies. The above data may be provided to the police station or emergency medical center. The above computation method may be 1/1000000˜ 1/10000000 equal scale computation method, namely, land area and architecture computation method in the status diagram. The above computation method may be performed using the telematics terminal attached to each vehicle and the specification of the vehicle such as length and width and attached position of the telematics.

The data of all terminals positioned near the accident site may be transmitted to the server 50 and may be stored in the database 70 so as to prevent the flee of the accident person.

When the owner of the terminal is missed or the wireless terminal is lost or damaged, the evidences may be lost. However, in the present invention, the impact time, image and voice data when the terminal 10-1 is hit are stored for thereby preventing the accident. In this case, a policeman, security service person or a police cop may be moved to the position of the terminal for thereby capturing the accident person.

The operation when the user selects the road corporation will be described.

FIG. 13 is a flow chart illustrating an operation of a data exchange system when a user selects a road corporation service according to the present invention.

The user of the terminal 10-1 selects a menu by operating his keypad 800. When the service item is selected, the controller 100 displays the service item on the display unit 700.

When the user selects the road corporation service and then the departure and destination, the controller 100 of the terminal 10-1 transmits the recognition data of the terminal 10-1 and the departure and the destination to the server 50. At this time, it is possible to send together with the transmission time data with reference to the timer 1100. In necessary, the server 50 may previously provide the junction point data and rate data in a step S1010.

The road data process unit 507 of the server 50 is paid through the payment process unit 506 after the rate is paid in a step S1020. When the payment is finished, the road rate process unit 507 of the server 50 transmits a terminal data, a vehicle data, a destination, a departure and a payment data to the road corporation server 1200 in a step S1030. At this time, when the payment is performed, the rate data is stored in the terminal, and the server 50 performs the payment. A separate server may perform the payment function.

The road corporation server 120 transmits the terminal data, vehicle data, destination, departure place and payment data to the departure place and destination tollgate system 1300 in a step S1040.

Each tollgate system 1300 guides the vehicle registration number using a light emitting plate so that a corresponding vehicle passes through by setting a separate line in a step S1050.

In the case that the departure place or destination is changed, the user selects a change on the road corporation menu using the keypad 800, and the departure place or destination is changed.

The controller 100 of the terminal 10-1 transmits a recognition data of the terminal 10-1 and a changed departure place and destination data to the server in a step S1060. If necessary, the controller 100 may further include a road data process module for storing the vehicle position data and running data. The data process module stores the GPS-related recognition data, transmission and receipt time data, peripheral terminal position status diagram and service item data, with the data being controlled. In the case of the vehicle, the status diagram data, which is the position data of the peripheral terminal with respect to the running data, may be transmitted together with the GPS-related recognition data, transmission and receipt time data and service item data. The vehicle running data and terminal position data may be transmitted to the server 50 or the road corporation server 1200, and the peripheral terminal position data and status diagram may be used as the data materials in the case of accident.

The road rate process unit 507 of the server 50 pays back or is further paid through the payment process unit 506 with respect to the previously paid rate after the rate is computed in a step S1070. After the pay back or further payment is performed, the server 50 transmits a terminal data, a vehicle data, a destination, a departure place and a payment data to the road corporation server 1200 in a step S1080.

The road corporation server 1200 transmits the terminal data, vehicle data, changed destination or changed departure data and payment data to the departure place and destination tollgate system 1300 and informs the tollgate system 1300, before the change, of the same contents in a step S1090.

Each changed tollgate system 1300 sets a separate line and guides the vehicle registration numbers using light emitting plates so that a corresponding vehicle passes through.

In the road rate payment method, since the road rate payment is previously performed, the traffic condition becomes better.

In the case of the research according to an embodiment of the present invention, the terminal is installed at a certain position such as a department store or other places to be searched, the data of the users of the terminals are researched within a certain radius range. The research may be conducted with respect to the persons of certain ages or sex from the member data. The preferences of the election candidate can be easily surveyed by adapting the present invention to the election. For example, the server classifies the persons from the member data list by ages, sexes, education levels, jobs, etc. and transmits a certain data to the terminals of the members having voting rights, with the data being provided so as to inquire the preferences of persons. A result of the inquiry is collected for thereby judging the preferences of the candidates. The present invention may be well adapted to the poll of inquiring the preferences of the candidates.

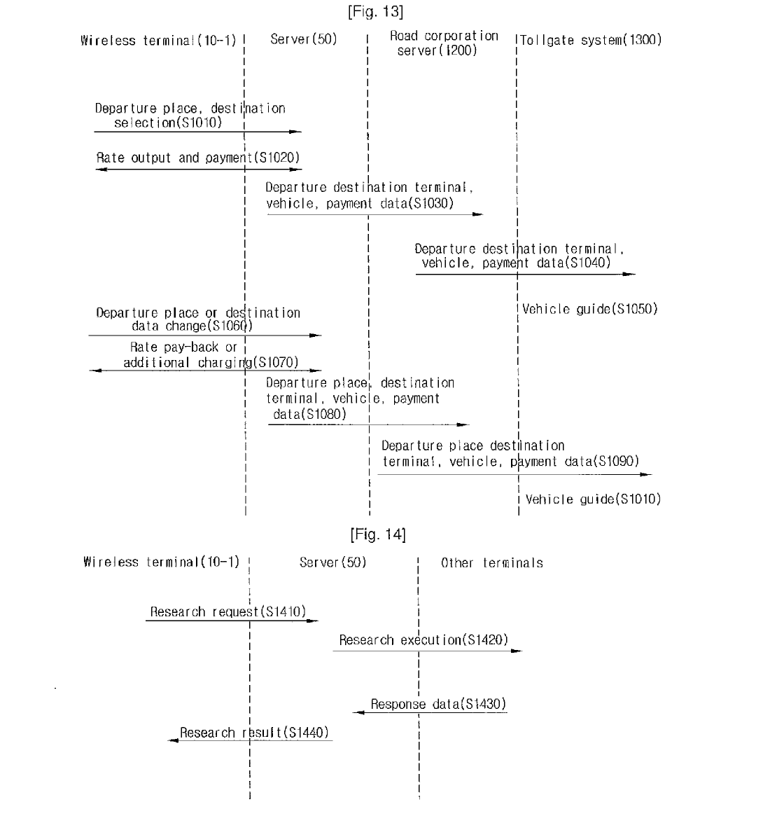

The research concerning the election will be described with reference to FIG. 14.

FIG. 14 is a flow chart of a data exchange system when a research service is selected among the service items.

The user of the terminal 10-1 selects a menu by operating the keypad 800, and when the service item is selected, the controller 100 displays the service item on the display unit 700.

As the user selects the research and inputs the contents for the poll, the controller 100 of the terminal 10-1 transmits the recognition data of the terminal 10-1 and the poll survey content to the server 50 in a step S1410. At this time, the transmission time data may he sent together with reference to the timer 1100.

The research process unit 508 of the server 50 receives the terminal data of the member from the member database 71 and transmits the poll survey content based on the ages, sex, region-based member, etc. in a step S1420.

When the response data are received from each terminal, the research process unit 508 collects the data and creates a poll survey result. The created poll survey result is transmitted to the terminal 10-1 which requested the poll survey in a step S1440. The result is stored in the research database 76 and is used based on the requests from the other terminal or other elements.

When the user selects a financial field, while seeing the status diagram data by pressing a corresponding key on the GPS-related recognition data and service item data, the bank or credit card company is selected with voice or text. The bank account or menu is selected while seeing the account or menu of a corresponding bank or credit card company. At this time, the recognition data related with the GPS of the family from the server is classified in various kinds of data terminals such as a digital television, etc. The classification data includes a recognition data related with the GPS formed when the transaction with the bank and card is performed, and the service item data and status diagram data with respect to the transmission and receipt time data. In addition, the server can inform the recognition data related with the GPS of the family member of the input and output payment limits with respect to the card or cash or can adjust the payment limits. In addition, if necessary, the integrated financial transaction process may he performed with the voices or texts. When the finance is selected with voices or texts by allowing the card reader to read the card in sync with the terminal, a desired bank or credit card company may be selected. When a corresponding bank is shown, and a financial data of a member is shown, it is needed to input a biological recognition code. When a corresponding bank account is shown, a desired financial transaction can be performed.

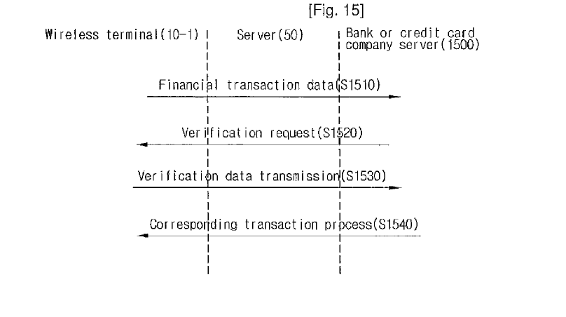

The financial transaction will be described with reference to FIG. 15.

FIG. 15 is a flow chart of a data exchange system when finance is selected among the service items.

First, the user of the terminal 10-1 selects a menu by operating the keypad 800. When the service item is selected, the controller 100 displays the service item on the display unit 700.

When the user selects the finance, a corresponding credit card company is shown or a bank list is shown. When the user selects a corresponding bank or a credit card company and a corresponding financial transaction such as money transfer, etc., the controller 100 of the terminal 10-1 transmits the recognition data of the terminal 10-1 and the selected transaction data to the bank or credit card company server 1500. At this time, the transmission time data may be transmitted together with reference to the timer 1100.

The bank or credit card company server 1500 requests a verification for verifying the member in a step S1520.

The user contacts his fingerprint with the verification sensor 410 or transmits a verification data to the credit card company server 1500. When the verification is finished, the bank or credit card company server 1500 processes a corresponding transaction, and a result of the process is transmitted to the terminal 10-1 in a step S1540.

The above procedures may be modified into various methods. It is possible to implement the above procedure with voice recognition or integrated financial transaction.

The financial transaction may be possible through the server 50. The financial transaction may be performed in relation with the bank or credit card company server 1500 through the financial process unit 509. The procedures are same.

In the embodiments of the present invention, the advertisement service is possible. In this case, the member list may be stored in the memory 900 or the server 50.

The advertisement may be performed with classification by ages, sexes, regions, etc. The server 50 may output the advertisement by the ages, student levels, groups or sexes of the members.

In the case of the financial transaction, the recognition data related with the GPS, the position data of the peripheral terminal, the status diagram data, the transmission and receipt time data, and the service item data are transmitted and stored in the server 50 or the financial organ. In addition, the data terminal (television, terminal, etc.) of the home of the terminal owner may be provided with the recognition data related with the GPS, the service item data, the transmission and receipt time data, the position data of the peripheral terminal and the status diagram data. In the case of the financial transaction, the financial transaction is limited with respect to the member of the family, and the transaction may require an approval from the family.

The terminal according to the present invention may be formed of a wireless terminal, a GPS, a TRS, an infrared ray, an ultrasonic wave, a laser, CT 1-2, a blue toot h, a ubiquitous, USB, etc. In addition, it may have a terminal inherent code, a certain code or various types of data as a recognition data.

In addition, the terminal according to the present invention checks the waveform during the radio generation from the inherent number creation wireless terminal and forms the checked data on a status diagram in a state that a plurality of terminals are provided.

At this time, as the radio transmitted from the opponent's terminal is checked like checking the earthquake or radar, the list of the owner of the wireless terminal is checked. The radio generation region may be checked using the GPS. The status diagram may be formed of an arrival of the radio generation, a radio wave generation wireless terminal, an inherent number and generation and propagation time of a wireless terminal which receives radio waves, a radio arrival time, etc. The check may be performed with respect to the inherent number of the wireless terminal and the generation and propagation time, and a result of the check may be printed. The radio wave generation wireless terminal generates radio waves by pressing an operation key with a closet contact so as to create an inherent number. The received radios are inputted into the wireless terminal which receives radios for thereby creating an inherent number. The inherent number may be previously stored into the memory.

In the embodiment of the present invention, a meter may be attached to a vehicle or an inherent number recognizer may be attached to the telematics, so that it is possible to create an inherent number and to print a status diagram or to transmit the same in the case of a traffic accident, whereby the status diagram may be used as an evidence when a traffic accident occurs in an emergency situation. It is possible to know the owner (offender) of the terminal while seeing the status diagram and to know the telematics-attached inherent number creation vehicle for thereby collecting evidences.

In the present invention, it is possible to send a help signal when people lose their ways and to start am emergency contact network.

In the home, it is possible to provide a connection of a status diagram, CCTV, an administrative work, an emergency contact network, a vehicle, a family wired or wireless telephone or a checking function of the saline by connecting a television with a terminal or server.

### INDUSTRIAL APPLICABILITY

As described above, the user can be provided with a desired service among the service items of the terminal using a data exchange system between terminals or between a terminal and a server according to the present invention. Since the user is easily provided with an electronic commerce, a meeting, a status diagram data, a research, a road corporation data, a joint purchase, a reverse auction, finance, emergency situation, etc., it is possible to achieve more convenient life. In addition, the arrangement statuses of the peripheral terminals are stored by the time, and an evidence material can be obtained with respect to a certain situation such as crime, accident or usual time. In the case of an emergency situation, certain help may be requested to the peripheral terminals. Data exchanges can be efficiently performed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims.

1. In a terminal which communicates with at least one peripheral terminal and exchanges data, an improved terminal, comprising:
a communication unit which communicates with another terminal;
a memory which stores a data including a recognition data of a terminal; and
a controller which requests a desired data to the other terminal through the communication unit, receives a requested data and performs a corresponding service.

2. The terminal of claim 1, further comprising a GPS module for receiving a signal of a GPS satellite and outputting a data needed for a position computation, with said controller being provided so as to receive position data of other terminals and creating a status diagram data based on the position of other terminals and its position.

3. The terminal of claim 2, wherein said controller includes:
a peripheral terminal registration unit which stores a data including a recognition data of other terminals; and
a peripheral terminal inquiry unit which outputs a data of the peripheral terminal stored in the memory in response to an external request.

4. The terminal of claim 3, wherein said peripheral terminal registration unit receives a recognition data from other terminals and stores into the memory together with a receiving time data, and said peripheral terminal inquiry unit outputs the peripheral terminal data stored in the memory by the stored recognition data receipt time.

5. The terminal of claim 2, further comprising an impact detection sensor for detecting an impact applied to the terminal, with said controller being adapted to allow the terminal to connect with a previously set emergency contact through the communication unit when the impact detection sensor detects an impact for thereby informing an emergency situation.

6. The terminal of claim 5, wherein said controller further includes a road data process module for storing a position data and running data of a vehicle.

7. The terminal of claim 1, wherein a service performed by said controlled includes at least one among a meeting request, an electronic commerce, an emergency situation, a road corporation, a research, a joint purchase, a reverse auction, a financial service, etc.

8. In a terminal which communicates with at least one peripheral terminal and a server and exchanges data, an improved terminal, comprising:
a communication unit which communicates with another terminal or the server;
a memory which stores a data including a recognition data of a terminal; and
a controller which requests a data of other terminals to the server through the communication unit, receives a requested data and performs a corresponding service.

9. The terminal of claim 8, further comprising a GPS module for receiving a signal of a GPS satellite and outputting a data needed for a position computation, with said controller receiving a status diagram having his position data and position data of other terminals from the server for thereby performing the service.

10. The terminal of claim 9, wherein when the service is a meeting, said controller selects an opponent's terminal among the other terminals of the status diagram and transmits the contents of the meeting proposal and receives and transmits a data based on an allowance of the opponent's terminal.

11. The terminal of claim 8, wherein when the service is a road corporation service, said controller receives a rate data concerning a destination and a departure place from the server and pays the rate.

12. In a terminal which communicates with at least one peripheral terminal and a server and exchanges data, an improved terminal, comprising:
a communication unit which communicates with another terminal or the server;
a memory which stores a data including a recognition data of a terminal;
an input unit which receives a user's selection; and
a controller which requests a data needed to other terminals through the communication unit, receives a requested data, performs a service selected by the input unit, and transmits a result of the same to the server.

13. The terminal of claim 12, wherein when the service is an electronic commerce, said controller receive a product data from the other terminals, performs an electronic commerce and transmits a result of the same to the server.

14. The terminal of claim 13, wherein said controller pays a certain rate so as to receive a certain data of the other terminals.

15. In a data exchange system which communicates with at least one first terminal and exchanges a data, an improved data exchange system, comprising:
a database which stores recognition data of a plurality of terminals including the first terminal and a service data corresponding thereto; and
a server which transmits a service data to the first terminal based on a service request data inputted from the first terminal.

16. The system of claim 15, wherein said server informs the emergency contact of the current situation when the first terminal informs an emergency situation, with said emergency contacts being corresponded to the first terminal and being stored in the database.

17. The system of claim 15, wherein when the first terminal requests a data concerning a peripheral status of his place, the server transmits a status diagram data including the position data of the first terminal and the terminals positioned at a certain distance from the first terminal to the first terminal or at least one data terminal positioned outside.

18. The system of claim 15, wherein when the first terminal requests a data of the second terminal, which is an electronic commerce destination, said server transmits a product related data of the second terminal to the first terminal and processes a payment in case of order.

19. The system of claim 15, wherein when the first terminal requests a data of the second terminal, which is a meeting destination, said server pays a certain amount of money and transmits a personal data of the owner of the second terminal to the first terminal.

20. The system of claim 15, wherein when the first terminal requests an expressway rate data of a road corporation, said server provides a rate data based on a destination and departure place and transmits a terminal data, a vehicle data, a payment data, and a destination and departure place data to the road corporation server after payment.

21. In a data exchange system which communicates with at least one first terminal and receives a status diagram data which is the position data of the terminals including the first terminal from a mobile communication service company and exchanges the data, a data exchange system, comprising:
a database which stores the recognition data of a plurality of wireless terminals including a first terminal and a service data corresponding thereto; and
a server which transmits a service data and the status diagram data to the first terminal in accordance with a service request data inputted from the first terminal.

22. In a data exchange method which includes a database and a server and communicates with at least one terminal and exchanges data, an improved data exchange method, comprising:
a step in which the first terminal transmits a service request data to the server together with his recognition data; and
a step in which the server transmits a service data corresponding to the service to the first terminal in accordance with the service request data.

23. The method of claim 22, wherein said step, in which the server transmits the service data corresponding to the service to the first terminal in accordance with the service request data, includes a step in which the server transmits a status diagram data formed of a position data of the first terminal included in the recognition data and a position data of the terminals positioned at a certain distance from the first terminal.

24. The method of claim 23, wherein said step, in which the server transmits a service data corresponding to the service to the first terminal in accordance with the service request data, includes a step in which in the case that the service is a meeting service, and when the data of the selected second terminal is inputted from the first terminal, the server transmits a detailed data of the second terminal to the first terminal.

25. The method of claim 23, wherein said step, in which the server transmits a service data corresponding to the service to the first terminal in accordance with the service request data, includes a step in which when the service is a road corporation service, the server receives a rate data concerning a destination and departure place and pays the rate.
